(19) United States
(12) Patent Application Publication
(10) Pub. No.: US 2012/0132012 A1
(43) Pub. Date: May 31, 2012

(54) MEANS AND PROCESS FOR MEASURING THE DEFORMATION OF A ROTOR BLADE UNDER STRESS

(75) Inventors: Michael Weigel, Wasserburg (DE); Joachim Tiedeke, Kreuzlingen (CH)

(73) Assignee: BAUMER INNOTEC AG, Fraunfeld (CH)

(21) Appl. No.: 13/303,994

(22) Filed: Nov. 23, 2011

(30) Foreign Application Priority Data
Nov. 25, 2010 (EP) 10014977.2

(51) Int. Cl. G01L 1/24

(52) U.S. Cl. 73/862.624

(57) ABSTRACT

A device and process for measuring the deformation of a rotor blade under stress is provided. A twisting and, separately therefrom, a lateral displacement of a transmitter/receiver is measured and the error of measurement present otherwise due to the twisting is compensated.

### CROSS REFERENCE TO RELATED APPLICATIONS

This application claims the benefit of priority under 35 U.S.C. §119 of European Patent Application EP 10014977.2 filed Nov. 25, 2010, the entire contents of which are incorporated herein by reference.

### FIELD OF THE INVENTION

The present invention pertains to a means as well as to a process for measuring the deformation of a rotor blade under stress, especially of the rotor blade of a wind power plant.

### BACKGROUND OF THE INVENTION

Rotor blades, especially rotor blades of wind power plants, are subject to high stresses. These are manufactured, as a rule, from fiber-reinforced plastics and are subject to a great degree of deflection at high wind velocities. The structure of the rotor blade may be damaged by this. Furthermore, it may happen in the worst case that the bent rotor blade strikes a tower of the plant or that it even breaks.

It is therefore known to monitor the deformation, especially the bending, of a rotor blade, in order to make it possible to reduce deformation under an excessively high stress by adjusting the angle of attack of the rotor blade. The plant must be stopped altogether at high wind velocities.

Such a means for measuring the deformation of a rotor blade is shown, for example, in German Patent Specification No. DE 10 2006 002 708 B4.

A transmitter/receiver unit, comprising a light source, preferably a light emitting diode (LED) or a laser diode, and a locally resolved imaging sensor (for example, a charge-coupled device (CCD), complementary metal oxide semiconductor (CMOS)) is arranged here together with an imaging system in the vicinity of the hub of the rotor blade.

A retroreflector, especially a triple mirror or an array of triple mirrors, or other retroreflecting solutions, via which the light emitted by the transmitter is reflected onto the locally resolving sensor, is located at a spaced location from the transmitter/receiver unit. The deformation of the rotor blade can be determined based on the position of the light spot on the locally resolving sensor.

The site of imaging on the locally resolving sensor is proportional here to the angles of the reflectors in relation to the optical axis of the imaging system.

The deflection of the rotor blade can be determined with such a system in a relatively simple manner.

However, it was found that even if the transmitter/receiver unit is arranged close to the hub of the rotor, the area in which the transmitter/receiver unit is located likewise undergoes deformation.

The transmitter/receiver unit is typically arranged at a bulkhead (the so-called platform) of the rotor blade, which extends between the flange and the rotor blade proper. Such a bulkhead shall prevent larger amounts of water or parts flying around from entering the hub of the rotor and thus causing mechanical damage. The rotor blade is usually essentially cylindrical in the area between the hub and bulkhead, i.e., it has no blade structure, which would be exposed to the air flow and would thus contribute to the rotation of the wind power plant. The area between the hub and bulkhead is therefore usually relatively stiff.

Nevertheless, a slight twisting and lateral displacement of the transmitter/receiver unit relative to the principal axis of the rotor blade may occur in transmitter/receiver units, especially those arranged at the bulkhead, so that the measurement to the reflector is no longer proportional to the deflection of the rotor blade, even though the measuring range starting from the transmitter is usually sufficient to make measurement possible when a triple mirror is used.

However, an error of measurement, which reduces the accuracy of the measurement, does occur because of the angular deviation and the lateral displacement of the transmitter/receiver unit.

This error of measurement comes into being, as a rule, in particular due to the fact that an elliptical deformation of the part of the rotor blade occurs that usually has a regular cylindrical shape in the flange area, i.e., has a round cross section. This deformation also leads to a deformation of the bulkhead, as a result of which a transmitter/receiver unit attached thereto changes the alignment. Since the above-described principle of measurement is based on measuring a change in angle, the deformation acts directly as an error of measurement in the form of an angle error.

### SUMMARY OF THE INVENTION

An object of the present invention is to at least reduce said drawbacks of the above-described state of the art.

One object of the present invention is, in particular, to compensate for the error of measurement occurring because of a twisting and/or lateral displacement of a transmitter and/or receiver unit.

The object of the present invention is accomplished by a device for measuring the deformation of a rotor blade under stress as well as by a process for measuring the deformation that includes providing a rotor blade, at least one transmitter arranged at the rotor blade and at least one receiver and a lateral displacement and/or twisting measuring means for measuring a twisting and/or lateral displacement of the transmitter and/or receiver relative to a rotor blade reference axis.

The present invention pertains to a means for measuring the deformation of a rotor blade under stress, especially of the rotor blade of a wind power plant.

The measuring means comprises at least one sensor arranged at the rotor blade and at least one transmitter and receiver. The receiver and sensor may also be integrated in one assembly unit, as is provided in one embodiment of the present invention.

The transmitter and receiver are preferably designed as an imaging system. However, it is also conceivable to use other measuring methods.

For example, a transmitter/receiver unit may be arranged at the rotor blade in the vicinity of the hub.

A reflector, which reflects the signal sent by the transmitter, especially sent by the transmitter as light of a light-emitting diode, is arranged at the rotor blade at a spaced location from the transmitter and receiver.

Since the principle of measurement is based on detecting the change in the position of a measuring point in relation to a reference axis or a reference system of coordinates and thus inferring the deformation of the rotor blade, it is seen that a signal must travel from the measuring point to a receiver.

This is possible, for example, with the above-described reflector.

However, it is also possible to place the transmitter, e.g., in the form of a light source, at the measuring point. Even though this embodiment of the present invention is usually somewhat more complicated, it is also less susceptible to interference from interfering external effects such as condensation, dust or rain.

It is apparent that the term “measuring point” is used to describe a system of coordinates in an idealized form and the signal source itself as a three-dimensional device is not a point in the mathematical sense.

According to the present invention the measuring device has a lateral displacement and/or twisting measuring means for measuring a twisting and/or lateral displacement of the transmitter and/or receiver in relation to a reference axis. By determining the angle error of the transmitter and/or receiver during a twisting thereof and the lateral displacement, the error can be determined and incorporated in the calculation of the deformation, especially deflection of the rotor blade and thus compensated. A twisting is defined as an angle deviation of the transmitter and/or receiver in relation to the position in the stress-free state or in relation to a reference axis of the rotor blade. The lateral error is the displacement of the main point of the receiving optical system in the plane extending at right angles to the rotor blade reference axis.

A reference axis is defined as any axis that can be used as a reference to determine a change in the position of the measuring point and hence a deformation of the rotor blade.

In a preferred embodiment of the present invention, the lateral displacement and/or twisting measuring means for measuring a twisting and/or lateral displacement comprise a light beam, which is directed from a reference point to a surface sensor.

In one embodiment of the present invention, the lateral displacement and/or twisting measuring means is designed such that measurement of the twisting of the transmitter and/or receiver is performed independently from the lateral position thereof.

The light beam is imaged, in particular, by means of a reference collimator on a surface sensor. The light beam can thus be projected by means of the reference collimator into infinity and imaged onto the surface sensor by means of another collimator, especially a convergent lens. It is ensured by this arrangement that a change in the position of the light spot on the surface sensor corresponds only to the twisting of the receiver and is not distorted by a possibly simultaneous lateral displacement.

The lateral displacement can be measured at the same time via another channel, but this is not necessary in most applications, because compensation of the error of measurement caused by the twisting is possible for a sufficiently accurate measurement.

As is conceivable in another embodiment, the lateral displacement can be inferred on the basis of the intensity profile on a surface sensor or a Shack Hartmann sensor, comprising a surface sensor and a collimator array, without further means, such as another surface sensor, being necessary herefor.

Besides the position of a reference point on the sensor, the intensity profile can be determined via a second channel in order to infer the lateral displacement besides the twist angle.

The reference collimator may comprise especially an LED light source or be formed by a retroreflector illuminated by the transmitter or receiver.

The lateral displacement and/or twisting measuring means for measuring a twisting and/or lateral displacement may comprise a reflector and/or a light source, which is arranged in the vicinity of the hub of the rotor blade at a shorter distance from the transmitter and/or receiver than the reference point.

In particular, a reference point, which is used as the origin of a system of coordinates for determining the deformation, may be arranged at the hub of the rotor.

To detect the reference point, the receiver may comprise a sensor with a second measuring channel, which is aligned with the reference point.

The reference point, in the immediate vicinity of which a reflector or a transmitter is arranged, is preferably provided at a point that has a smaller position deviation in the stressed state than the point at which the deformation is measured, i.e., the measuring point.

Thus, the receiver is preferably located between a reference point arranged on the hub side and a measuring point arranged on the blade side.

In a simple embodiment of the present invention, the detection of a twisting of the transmitter and/or receiver is performed by means of another reflector and transmitter/receiver channel, which is arranged at a shorter distance from the transmitter and/or receiver than the first reflector. Consequently, a reference point or a reference mark is provided, which is preferably arranged in the vicinity of or at the hub of the rotor. The further reflector, also called reference reflector below, is thus preferably located in an area that undergoes a small deformation under stress at best. Furthermore, it is also conceivable to determine the ratio of a deformation of the rotor blade in the area of the reference reflector to the deformation of the reflector and to include this in the measurement.

However, the reference reflector is preferably located in the area close to the hub, so that the deformation of the area in which the reference reflector is arranged can be ignored.

The further reflector is preferably arranged at a point of the rotor that undergoes a smaller change in position and hence undergoes a smaller deflection in the stressed state than the point at which the other reflector is arranged.

The determination of the twisting of the transmitter and/or receiver via the second reflector is preferably likewise performed optically, especially likewise by means of a light-emitting diode and/or by means of a surface sensor, for example, a CCD or CMOS receiver.

The transmitter is preferably designed as a light source, especially as a light-emitting diode or a plurality of light-emitting diodes. This saves energy and the monochromatic light can be better distinguished from the ambient light, so that the risk of the receiver being compromised by ambient light is reduced.

The reflector as well as the reference reflector are preferably designed as triple mirrors, triple prisms, arrays of triple mirrors or triple prisms or of suitable retroreflectors.

The drawback of this embodiment is especially that, particularly when the distance of the reference point, hereinafter also called reference mark, from the transmitter/receiver channel is very much shorter than the distance of the measuring point, hereinafter also called measuring mark, from the transmitter/receiver channel, lateral displacement and twisting cannot be separated from each other in the reference path. A lateral displacement of the transmitter/receiver channel relative to the reference mark has the same effect as a twisting due to the short distance.

At the relatively great distances of the measuring mark from the sensor, a twisting of the sensor has primarily an adverse effect, and only this must be corrected in a first approximation.

A variant of the present invention therefore pertains to ensuring that only a twisting is detected by a second channel and the lateral displacement does not distort the compensation measurement.

A reference collimator can be used for this instead of a light source without an imaging optical system. This collimator is designed such that a light source, preferably an LED or a laser diode, is imaged into infinity by means of a suitable optical system (collimated beam). The receiving optical system in the reference path or in the device for determining the twisting of the transmitter/receiver is likewise set such that this will image images, which come from infinity, onto the locally resolving surface sensor (preferably a CCD, CMOS receiver, PSD or four-quadrant diodes). As long as the beam of the reference collimator sufficiently lights the aperture of the receiving optical system of the reference path, the pure angle error of the mechanical structure of the transmitter/receiver channel relative to the reference surface can thus be determined. The twist angle is proportional to the spot position on the receiver. The angle errors to the reference surface, which are thus determined, can be used to correct the measured value concerning the angle error. The receiver and the device for measuring the twist are mechanically connected to one another.

To also make it possible to detect the lateral displacement in addition to the angle error, the energy distribution in the wave front of the output signal of the reference collimator can be analyzed in a variant via a “Shack Hartmann” sensor, which is known per se. With this further embodiment, every individual element acts basically in the same manner as the collimator structure described farther above. The lateral position of the beam relative to the Shack Hartmann sensor can be determined with this further embodiment by the inhomogeneous beam profile of the collimated beam by measuring the energy of the individual points and by forming a focus or by applying the energy data to the model of the beam profile.

Twisting and, as is possible in the above-described variant of the present invention, also the lateral displacement can be determined by the knowledge of the geometry of the structure, especially the vector from the mechanical point of impact of the structure to the microlens array.

In one variant of the present invention, the light source is replaced with a reflector and the device for measuring the twisting of the transmitter/receiver channel can be supplemented with active lighting.

In one variant of the present invention, the transmitter and/or receiver have means for wireless transmission of measured signals. Thus, it is not necessary to provide cable ducts in the area of the hub.

In one variant of the present invention, the transmitter/receiver unit and/or the reference collimator have means for generating power in order to supply themselves with power. Such systems operating according to the principle of “energy harvesting” are known.

According to another variant, the reflectors are not designed as retroreflectors but they have a light source and means for power generation themselves. This increases the robustness against contamination, condensation and icing. Such an active reflector can be triggered either by a signal, for example, a light pulse sent in the direction of the reflector, synchronously with the lighting of the sensor, or the sensor synchronizes the lighting of the detector with the pulse frequency of the active reflector.

These are, for example, piezoelectrically operating systems, which gain energy by the expansion of the rotor in order to convert this into power. However, other means for generating power, for example, photocells, are conceivable as well.

Thus, the transmitter/receiver unit, or even the active reflector, does not need to be equipped with batteries, and, furthermore, no cable ducts are necessary for power supply.

The present invention pertains, furthermore, to a process for measuring the deformation of a rotor blade, especially by means of an above-described means.

A signal, especially a light beam, is sent by means of a transmitter to a receiver and the deformation of the rotor blade, especially the twisting of the rotor blade, is thus determined on the basis of a change in the position of the received signal. According to the present invention, the twisting of a transmitter and/or of a receiver is determined by imaging a reference point onto a surface sensor of the receiver.

In particular, a collimated light beam is generated by means of an optical system and a light spot is generated on the surface sensor by means of another optical system. The position of this light spot is essentially independent from a simultaneous, possible lateral displacement of the receiver, at least insofar as the surface sensor is still located in the detection area.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view showing first principles of measurement for determining the deformation of a rotor blade;

FIG. 2 is a schematic view showing a rotor blade, which is provided with a transmitter/receiver unit;

FIG. 3 is a schematic view showing principles of the transmitter/receiver unit;

FIG. 4 is a schematic diagram showing deformation of the rotor blade bulkhead (platform) under stress;

FIG. 5 is a schematic view showing the rotor blade in a stressed state;

FIG. 6 is a schematic view showing a means for measurement of error due to twisting of the transmitter/receiver unit;

FIG. 7 is a schematic view showing features and principles of a measurement of the lateral displacement and/or twisting measuring means;

FIG. 8 is a schematic view showing features and principles of a measurement of the lateral displacement and/or twisting measuring means;

FIG. 9 is a schematic view showing features and principles of a measurement of the lateral displacement and/or twisting measuring means with a reference collimator comprising a collimator light source and a lens;

FIG. 10 is a schematic view showing a collimated beam with a beam profile, which is imaged on a surface sensor by means of a microlens array; and

FIG. 11 is a schematic view showing a collimated beam with a beam profile, which is imaged on a surface sensor by means of a microlens array.

### DESCRIPTION OF THE PREFERRED EMBODIMENTS

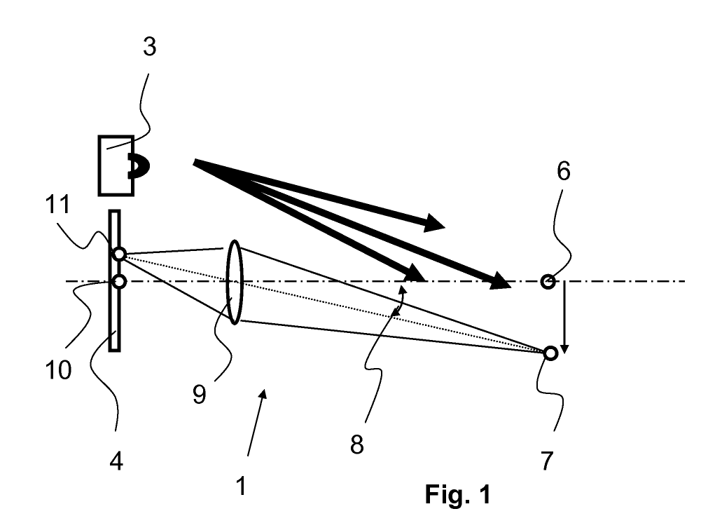

Referring to the drawings in particular, the present invention shall be explained in more detail below on the basis of exemplary embodiments shown schematically in reference to the drawings FIG. 1 through FIG. 11.

In reference to FIG. 1, a first principle of measurement for determining the deformation of a rotor blade shall schematically explained.

A device for measuring the deformation of a rotor blade 1 is schematically shown.

The device for measuring the deformation of a rotor blade 1 comprises a transmitter 3, here in the form of a light-emitting diode, as well as a receiver 4, here in the form of a CCD or CMOS receiver.

Light is emitted via transmitter 3, and this light is reflected by one retroreflector (or a plurality of retroreflectors) arranged at the rotor blade.

A first reflector position, which is designated by reference number 6, is shown here in the stress-free state. The retroreflector is located exactly centrally in relation to the first reflector position 6. The position of the light spot in the stress-free state is designated by reference number 10.

In the stressed state, for which the beam path is shown, the position of the retroreflector is shifted into the position designated by reference number 7. As a consequence, the light spot projected via a lens 9 onto the receiver migrates to the position designated by reference number 11. The reflection angle 8 can thus be determined, and the deformation of the rotor blade at the point of the retroreflector or of the retroreflectors can be calculated directly on the basis of this angle and of the known distance from the retroreflector.

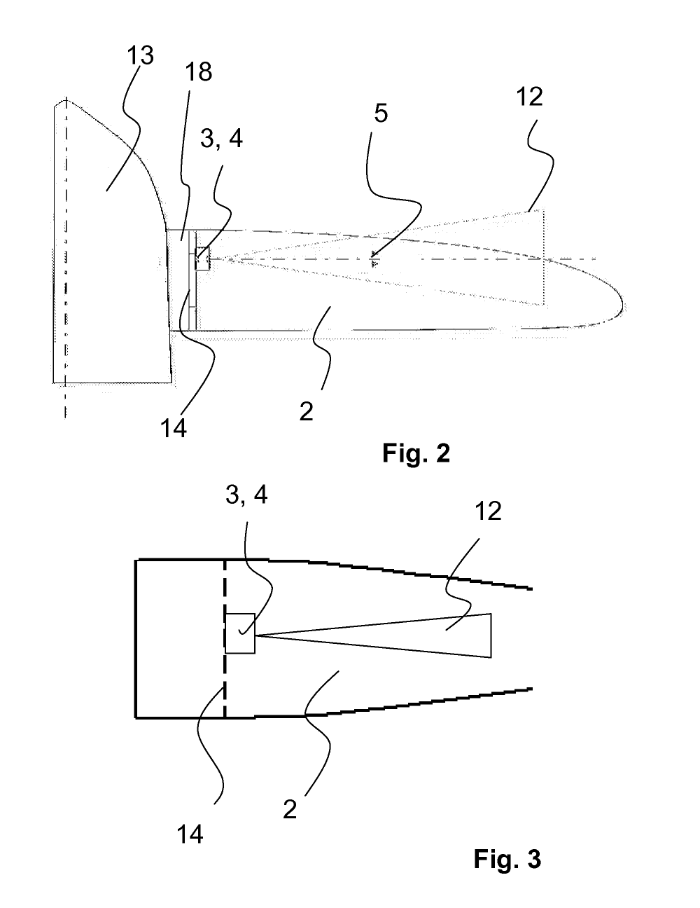

FIG. 2 schematically shows a rotor blade 2, which is provided with a transmitter/receiver unit 3, 4.

The rotor blade 2 is fastened in the hub 13 of a wind power plant by means of a flange 18. The transmitter/receiver unit 3, 4 is arranged, for example in the an interior cavity of the rotor blade 3, at a bulkhead (platform) 14, which adjoins the flange 18. However, any other position is possible as well. The requirement is a free field of view to the retroreflectors, providing a first measuring channel. In particular, the transmitter/receiver unit 3, 4 may be mounted directly in a cavity of the hub or flange as well.

A retroreflector 5, schematically shown here in the form of a triple mirror, which reflects light emitted by the transmitter 3 back onto the transmitter/receiver unit 3, 4, is located at a spaced location from the transmitter/receiver unit 3, 4. The cone of light originating from the transmitter in the form of a light-emitting diode is larger than or equal to the measuring area preset by the receiver 4. The measuring area (shown here schematically) is so large that the reflector 5 cannot migrate out of the measuring area.

FIG. 3 shows, in a schematic form, the principle of the transmitter/receiver unit 3, 4, which is arranged at the bulkhead (platform) 14 and emits a cone of light, which defines the measuring area 12, onto the rotor blade 2.

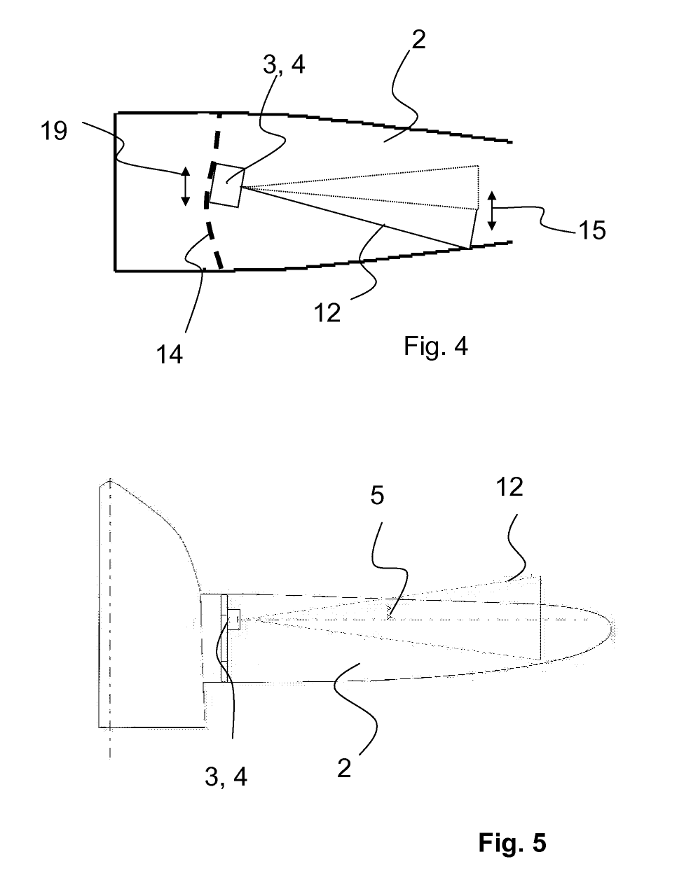

FIG. 4 shows, based on FIG. 3, as a schematic diagram the deformation of the bulkhead (platform) 14 under stress, which deformation leads to a twisting, i.e., to an angle deviation of the transmitter/receiver unit 3, 4 and to a lateral displacement in relation to the position in the stress-free state. It can be seen that the measuring area is no longer located exactly on the axis of the rotor blade 2, but has migrated. The change in direction is represented by arrow 15. The effect of the lateral displacement is represented by arrow 19. It is apparent that the deformations and lateral displacement shown here are represented in a greatly exaggerated form, and that this representation is, moreover, limited to two dimensions even though a three-dimensional problem is involved.

Analogously to FIG. 2, FIG. 5 shows the rotor blade 2 in the stressed state. Based on the twisting of the transmitter/receiver unit 3, 4, the measuring area 12 has migrated slightly downwardly in this view. Reflector 5 is still in the measuring area 12, but there is an error of measurement due to the twisting of the transmitter/receiver unit 3, 4 and the angle error associated therewith.

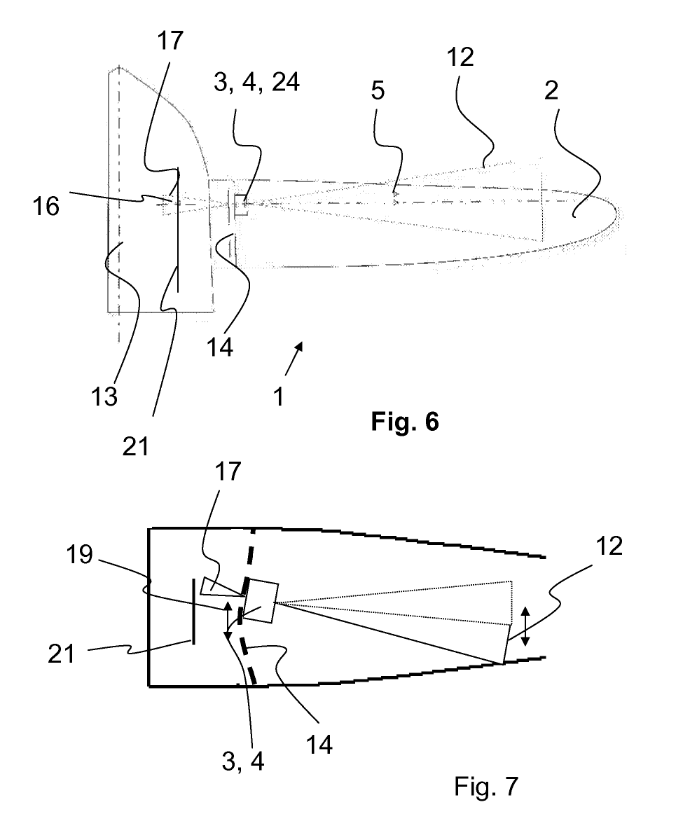

FIG. 6 shows, in a schematic form, how the error of measurement due to twisting of the transmitter/receiver unit 3, 4 can be compensated according to one embodiment of the present invention. Another reflector 16 is arranged for this as a reference reflector on the hub 13 of the rotor. The effect of a lateral displacement is superimposed here to the effect of a twisting and cannot be separated.

A measuring area is directed towards the reference reflector 16 with corresponding lighting via a second measuring channel of the transmitter/receiver unit arranged at the bulkhead (platform) 14. The measuring area is designated by reference number 17. The measurement of the deformation otherwise corresponds to the embodiments shown in FIGS. 4 and 5.

Since the twisting of the transmitter/receiver unit 3, 4 can be determined optically by the light spot reflected back by the reflector, this twisting can be taken into account in the determination of the deformation of the rotor blade 2 and does not act as a systematic error of measurement. A correction is possible only if a significant lateral displacement is not superimposed at the same time.

FIG. 7 shows the principle of measurement in a schematic form. Based on a twisting of the bulkhead (platform) 14, the transmitter/receiver unit 3, 4 is twisted as well, as a result of which the measuring area 12 is displaced.

The twisting of the transmitter/receiver 3, 4 can be determined based on the second measuring channel with the measuring area 17 and it can thus be included in the calculation of the deformation of the rotor blade. The error otherwise introduced by lateral displacements in case of great distances is not significant in this case. At short distances, as this is probable in the reference path 17, a lateral displacement 19 is superimposed to the measurement of the angle error. It is not possible to separate the effects, but it would be desirable for obtaining a high absolute accuracy. It is apparent that other systems can also be used to determine the twisting of the transmitter/receiver unit. In principle, any technique can be used with which two angles can be measured in relation to a reference plane.

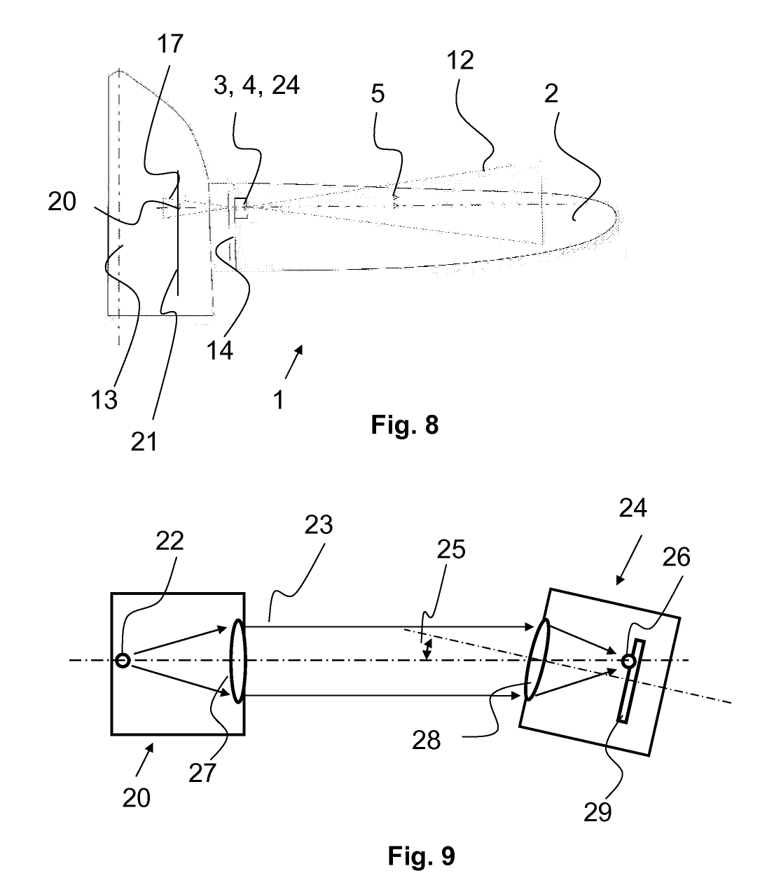

FIG. 8 shows, in a schematic form, how the error of measurement due to twisting of the transmitter/receiver unit 3, 4 can be compensated according to another embodiment of the present invention. A reference collimator 20 is arranged for this on a reference surface on the hub 13 of the rotor. The effect of a lateral displacement is superimposed to the effect of twisting here as well, but it is not measured in this embodiment of the present invention.

A measuring area and possibly a corresponding lighting are directed towards the reference collimator 20 via a second channel of the transmitter/receiver unit 3, 4 arranged at the bulkhead (platform) 14 with a transmitter/receiver channel 24. The measuring area is designated by reference number 17. The measurement of the deformation otherwise corresponds to the embodiment shown in FIG. 4 and FIG. 5.

Since the twisting of the transmitter/receiver unit 3, 4 can be determined optically by the measurement of the reference collimator 20, this twisting can be taken into account in the determination of the deformation of the rotor blade 2 and does not act as a systematic error of measurement. This measurement method measures only the angle components and makes these available for the correction, as will be described in even more detail below with reference to FIG. 9.

The embodiment using the reference collimator 20 provides a collimator light source that has collimated beam 23 that is imaged into infinity. The lateral displacement and/or twisting measuring means 24 includes these features for measuring the twisting of the transmitter/receiver channel with selectively not measuring the lateral displacement that is superimposed to the effect of twisting. In this case, the twist angle 25 may be detected based on the spot location 26 on the receiver. The collimated beam 25 is provided based on the lens 27 of reference collimator in cooperation with a reference path lens 28 which is attached to the receiver of reference path 29 of the lateral displacement and/or twisting measuring means 24.

FIG. 9 schematically shows how a beam 23 is imaged into infinity with the reference collimator 20, comprising a collimator light source 22 and a lens 27. The twist angle 25 is determined by measuring the spot location 26 in the lateral displacement and/or twisting measuring means for measuring the twist of the transmitter/receiver 24. This spot location is proportional to the twist angle 25.

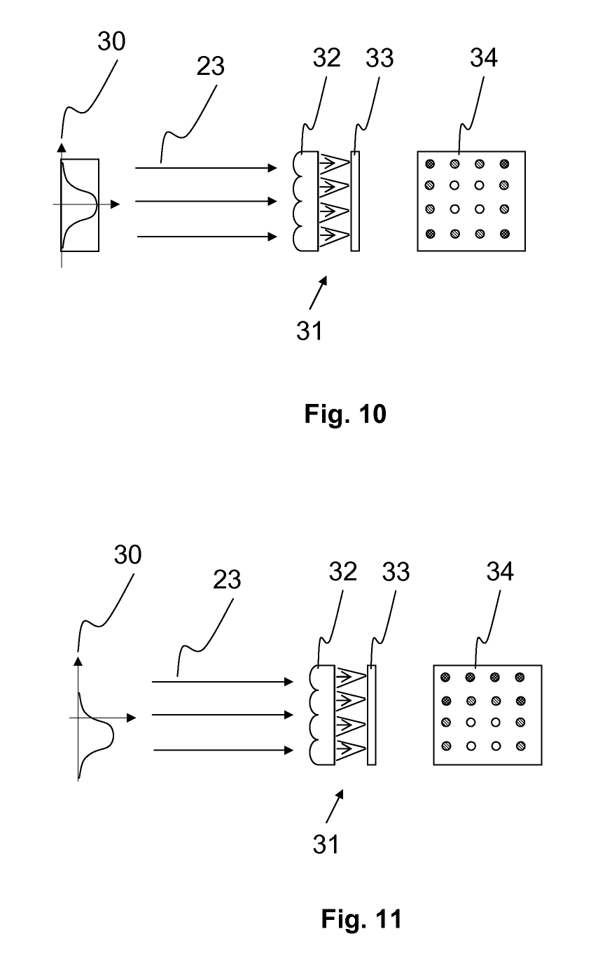

FIG. 10 and FIG. 11 show a collimated beam 23 with a beam profile 30, which is imaged on a Shack Hartmann detector 31 as a surface sensor 33 by means of a microlens array 32. The integral energy, which can be demonstrated in each spot on the locally resolving detector 33, is proportional to the integral energy of the corresponding part of the microlens array 32. Such an energy distribution of the spots 34 is used to determine the energy distribution in the plane of the aperture of the microlens array 32.

FIG. 10 shows a central energy distribution, whereas FIG. 11 schematically shows an asymmetrical distribution.

The embodiment of the present invention makes it possible to improve the accuracy of a system for calculating the deformation of a rotor blade in a very simple manner when angle errors and superimposed lateral errors are to be primarily compensated.

While specific embodiments of the invention have been shown and described in detail to illustrate the application of the principles of the invention, it will be understood that the invention may be embodied otherwise without departing from such principles.

### APPENDIX

### List of Reference Numbers

1 Device for measuring the deformation of a rotor blade
2 Rotor blade
3 Transmitter
4 Receiver of the measuring channel
5 Reflector (=measuring mark)
6 Reflector position 1
7 Reflector position 2
8 Reflection angle
9 Lens of measuring channel
10 Spot position on receiver 1
11 Spot position on receiver 2
12 Measuring area
13 Hub
14 Bulkhead (=platform)
15 Arrow (=angle twisting)
16 Further reflector (=reference reflector, reference mark)
17 Measuring area (=reference path)
18 Flange
19 Arrow (=lateral displacement)
20 Reference collimator
21 Reference surface
22 Collimator light source
23 Imaging into infinity/collimated beam
24 Device for measuring the twisting of the transmitter/receiver channel
25 Twist angle
26 Spot location on the receiver of the collimated beam
27 Lens of reference collimator
28 Lens of reference path
29 Receiver of reference path
30 Beam intensity profile of reference collimator
31 Shack Hartmann detector
32 Microlens array
33 Surface sensor
34 Spots on surface sensor with energy distribution

What is claimed is:

1. A device for measuring a deformation of a rotor blade under stress, the device comprising:
a rotor blade deformation measuring means for measuring a rotor blade deformation with at least one transmitter arranged at the rotor blade and at least one receiver arranged at the rotor blade; and
a lateral displacement and/or twisting measuring means for measuring a twisting and/or lateral displacement of said transmitter and/or receiver relative to a rotor blade reference axis.

2. A device for measuring a deformation of a rotor blade in accordance claim 1, wherein said lateral displacement and/or twisting measuring means measures twisting of the transmitter and/or receiver independently from the lateral displacement.

3. A device for measuring a deformation of a rotor blade in accordance claim 1, wherein said means for measuring a twisting and/or lateral displacement comprises a surface sensor and a reference point in the form of a luminous spot, which is imaged via a collimator into infinity and onto said surface sensor.

4. A device for measuring a deformation of a rotor blade in accordance with claim 3, wherein the lateral displacement and/or twisting measuring means for measuring a twisting and/or lateral displacement comprises a reference collimator wherein the reference point can be imaged by means of the reference collimator designed as an LED light source.

5. A device for measuring a deformation of a rotor blade in accordance with claim 1, wherein:
said rotor blade deformation measuring means further comprises a reflector at a measuring mark, spaced a distance from said transmitter and/or receiver; and
said lateral displacement and/or twisting measuring means for measuring a twist and/or lateral displacement comprises a reflector or a light source at a reference mark, which is arranged at a shorter distance from the transmitter and/or receiver than said measuring mark.

6. A device for measuring a deformation of a rotor blade in accordance with claim 5, wherein the reference mark is arranged at the hub of the rotor.

7. A device for measuring a deformation of a rotor blade in accordance claim 1, wherein:
said rotor blade deformation measuring means further comprises a reflector at a measuring mark, spaced a distance from said transmitter and/or receiver with said receiver having a first measuring channel aligned with said measuring mark;
said lateral displacement and/or twisting measuring means for measuring a twist and/or lateral displacement comprises a reflector and/or a light source at a reference mark; and
said receiver comprises a sensor with a second measuring channel, which is aligned with said reference mark.

8. A device for measuring a deformation of a rotor blade in accordance claim 1, wherein said receiver is arranged between a reference point arranged on a hub side and a measuring point arranged on the blade side.

9. A device for measuring the deformation of a rotor blade in accordance with claim 8, wherein a reflector or light source is arranged at the measuring point.

10. A device for measuring a deformation of a rotor blade in accordance claim 1, wherein the transmitter and/or receiver is arranged at a platform located between a hub and the rotor blade.

11. A device for measuring a deformation of a rotor blade in accordance claim 1, wherein the transmitter is designed as a light source including at least one of a laser diode and a light-emitting diode.

12. A device for measuring a deformation of a rotor blade in accordance claim 1, wherein the receiver comprises an optical surface sensor.

13. A device for measuring a deformation of a rotor blade in accordance claim 1, wherein a twisting and a lateral displacement of the receiver and/or transmitter channel can be measured on the basis of the intensity profile of a surface sensor in the form of a Shack Hartman sensor.

14. A device for measuring a deformation of a rotor blade in accordance claim 1, wherein said lateral displacement and/or twisting measuring means comprises at least one transmitter, sensor and/or a light source, a reference collimator, with a power generator to supply power.

15. A process for measuring the deformation of a rotor blade, the process comprising the steps of:
providing at least one transmitter arranged at the rotor blade and at least one receiver;
providing a lateral displacement and/or twisting measuring means for measuring a twisting and/or lateral displacement of the transmitter and/or receiver relative to a rotor blade reference axis;
sensing a signal from a radiation beam which travels from a section of the rotor blade to the receiver;
determining a deformation by determining a displacement of the rotor blade on the basis of a change in the position of the received signal, wherein a twisting of a transmitter for sending the signal and/or of a receiver for receiving the signal, which twisting is caused by a deformation of the rotor blade, is measured by imaging a reference point onto a surface sensor of the receiver.

16. A rotor blade deformation measuring system comprising:
a rotor blade with a rotor blade platform;
a rotor blade deformation measuring means for measuring a rotor blade deformation with a transmitter and a receiver, said receiver being fixed to said platform; and
a lateral displacement and/or twisting measuring means for measuring a twisting and/or lateral displacement of said transmitter and/or receiver relative to a rotor blade reference axis.

17. A rotor blade deformation measuring system in accordance claim 16, wherein said lateral displacement and/or twisting measuring means measures twisting of the transmitter and/or receiver independently from the lateral displacement.

18. A rotor blade deformation measuring system in accordance claim 16, wherein said lateral displacement and/or twisting measuring means for measuring a twisting and/or lateral displacement comprises a surface sensor and a reference point in the form of a luminous spot, which is imaged via a collimator into infinity and imaged onto said surface sensor.

19. A rotor blade deformation measuring system in accordance with claim 16, wherein:
said rotor blade deformation measuring means further comprises a reflector at a measuring mark, spaced a distance from said transmitter and/or receiver;
said lateral displacement and/or twisting measuring means for measuring a twist and/or lateral displacement comprises a reflector and/or a light source at a reference mark, which is arranged at a shorter distance from the transmitter and/or receiver than said measuring mark; and
the reference mark is arranged at the hub of the rotor.

20. A rotor blade deformation measuring system in accordance claim 16, wherein:
said rotor blade deformation measuring means further comprises a reflector at a measuring mark, spaced a distance from said transmitter and/or receiver with said receiver having a first measuring channel aligned with said measuring mark;
said lateral displacement and/or twisting measuring means for measuring a twist and/or lateral displacement comprises a reflector and/or a light source at a reference mark; and
said receiver comprises a sensor with a second measuring channel, which is aligned with said reference mark.
